(19) United States
(12) Patent Application Publication
(10) Pub. No.: US 2026/0285724 A1
(43) Pub. Date: Sep. 24, 2026

(54) MULTIFUNCTIONAL-GROUP MODIFIED GREEN SCALE INHIBITOR FOR EFFICIENT INHIBITING CALCIUM SULFATE FORMATION AND PREPARATION METHOD AND APPLICATION THEREOF

(71) Applicant: Nanjing University, Nanjing (CN)

(72) Inventors: Hu YANG, Nanjing (CN); Xiaoyu SHI, Huizhou City (CN)

(21) Appl. No.: 19/390,036

(22) Filed: Nov. 14, 2025

(30) Foreign Application Priority Data
Mar. 24, 2025 (CN) 202510349455.2

(51) Int. Cl. C02F 5/10; C02F 103/00; C02F 103/02; C08F 251/00

(52) U.S. Cl. CPC C02F 5/10; C08F 251/00; C02F 2103/007; C02F 2103/023

(57) ABSTRACT

Disclosed are a preparation method and application of a green and efficient multifunctional-group modified scale inhibitor which can effectively inhibit calcium sulfate scale. Starch is used as the raw material for the scale inhibitor, potassium persulfate is used as the initiator, glycidyl methacrylate and acrylic acid are used as grafting monomers through grafting reaction to prepare a modified scale inhibitor with multiple functional groups. Graft chains containing carboxyl groups, ester groups, and epoxy groups can be introduced onto polysaccharide backbones. This endows the scale inhibitor with excellent chelation, dispersion, and lattice distortion properties, which can effectively inhibit the formation and growth of scale. The scale inhibitor prepared by the present invention can not only effectively inhibit the formation of calcium sulfate scale in static experiments, but also has a significant application effect in reverse osmosis systems, effectively alleviating the problem of membrane flux decline, thereby improving the stability of the water treatment system. It not only improves water treatment efficiency, but also meets the requirements of environmental friendliness, providing a new strategy for the control of calcium sulfate scale.

### TECHNICAL FIELD

The present invention relates to a multifunctional-group modified environmental-friendly scale inhibitor for efficient inhibiting calcium sulfate scaling, and preparation method and application thereof, and belongs to the technical field of water treatment.

### BACKGROUND ART

With the expansion of global urban scale and the continuous growth of population, the demand for freshwater has also been rising, which undoubtedly further highlights the issue of freshwater resource scarcity. Desalination technology for seawater and brackish water has become one of the important means to solve the problem of freshwater shortage. Reverse osmosis technology is widely used in desalination processes due to its low energy consumption and high desalination efficiency, and is one of the most common desalination technologies currently. However, the reverse osmosis technology faces a series of challenges in practical applications. Due to the presence of alkaline earth metals (such as calcium, magnesium, etc.) in water, these alkaline earth metals will undergo chemical reactions with some anions in water in the reverse osmosis system, leading to the formation of scale, especially the formation of sediments on membrane surfaces or in membrane pores. This scale not only affects the permeability of the membrane but also increases the energy consumption and operating costs of the membrane system. In addition, scaling is also a common problem in circulating cooling water systems in many industrial fields (such as power generation, chemical, and petroleum industries). The formation of scale not only affects heat exchange efficiency and increases energy consumption, but also poses potential hazards. Therefore, effectively inhibiting the formation of scale has important practical significance in both reverse osmosis and circulating cooling water systems.

In reverse osmosis systems, direct addition of scale inhibitors is one of the common methods to prevent scaling, and this strategy is widely popular due to its high efficiency, simple operation and low cost. However, although traditional phosphorus-containing and organic synthetic polymer scale inhibitors exhibit excellent performance in scale inhibition, the environmental issues which they have caused cannot be ignored. In particular, although phosphorus-containing scale inhibitors have high scale inhibition efficiency, their residual phosphorus may cause water eutrophication, thereby triggering a series of ecological and environmental problems. Therefore, both academia and industry are actively exploring solutions to this problem, gradually moving towards the research direction of phosphorus-free scale inhibitors, such as organic synthetic polymer scale inhibitors. However, although organic synthetic polymer scale inhibitors perform well in inhibiting scaling, they are usually multi-component copolymers, which not only have disadvantages such as high cost and difficulty in regulating molecular structure, but also are difficult to degrade in the natural environment after being discarded, posing potential harm to the environment as well. In recent years, polyaspartic acid, as a green scale inhibitor, has received widespread attention and has great application potential; however, it also has shortcomings such as relatively complex preparation conditions, a single functional group, and containing the nutrient element, i.e., nitrogen, in its structure. Therefore, the development of novel, highly efficient, phosphorus-free, nitrogen-free, environmentally friendly, biodegradable, and cost-effective scale inhibitors has become an important topic in research in this field.

Natural polymers, such as starch, cellulose, lignin, and chitosan, are derived from organisms such as plants, animals, and microorganisms, and are widely distributed in nature; these materials not only have good biodegradability, but also usually have advantages such as economic efficiency and environmental friendliness. Although most natural polymers themselves do not have a scale inhibition effect, they can have good scale inhibition performance through appropriate physicochemical modification methods. In fact, research on natural polymer scale inhibitors, such as lignosulfonate and others, has already attracted widespread attention and application as early as the 1960s. However, it was soon replaced by a large number of newly discovered synthetic scale inhibitors subsequently, such as organophosphorus scale inhibitors and the like. Therefore, the research on natural polymer scale inhibitors is far from systematic and comprehensive, and the scale inhibition performance also needs to be further improved.

In addition, among different chemical modification methods, graft copolymerization is a commonly used polymer chemical modification method, which can introduce various functional groups onto the polymer backbone and construct unique branched chain structures, enabling the polymer to simultaneously possess the advantages of the functional groups on the main chain of the raw material and also the grafted side chain, thus effectively improving its application properties. However, in previous studies, after excessive addition of scale inhibitors such as hydroxyethylidene diphosphonic acid and aminotrimethylene phosphonic acid, the scale inhibitors may interact with each other and adsorb on the membrane surface, thereby causing a decrease in membrane flux.

### SUMMARY OF THE INVENTION

The technical problem solved by the present invention is to provide a modified environmental-friendly scale inhibitor with both excellent scale inhibition effect and environmental protection characteristics is developed through molecular design and functional modification technology, using a natural polymer, i.e., starch, with excellent performance including low price and wide sources, as the raw material. This scale inhibitor can effectively inhibit scaling of calcium sulfate and at the same time control membrane fouling in a reverse osmosis system within a wide dosage range. Said multifunctional-group modified environmental-friendly scale inhibitor can not only effectively inhibit the formation of calcium sulfate scale in static water bodies, but also effectively alleviate the decline of membrane flux in the reverse osmosis system, thereby improving the stability of the water treatment system. Besides, it is not prone to produce flocculation effect, thus not prone to contaminate the reverse osmosis membrane at excessive dosages. Through applications in static experiments and reverse osmosis experiments, it can effectively inhibit the formation of calcium sulfate within a wide dosage range, exhibits good scale inhibition performance, and can be applied to control scaling in circulating cooling water and reverse osmosis systems.

In order to solve the above technical problem, the technical solution provided by the present invention is: a preparation method of a multifunctional-group modified environmental-friendly scale inhibitor, for which starch is used as the raw material, potassium persulfate as the initiator, glycidyl methacrylate (GMA) and acrylic acid (AA) as graft monomers, and the multifunctional-group modified environmental-friendly scale inhibitor obtained through graft copolymerization reaction, and the preparation route is as follows:

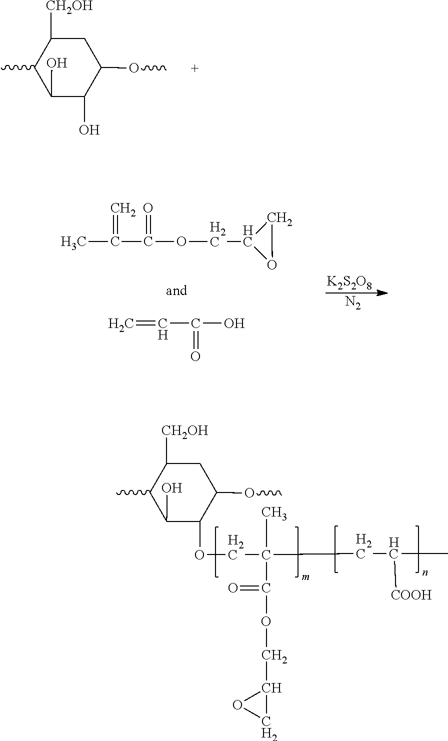

where: m, n are positive integers;
the specific steps are as follows:
starch is dispersed in aqueous sodium hydroxide solution, and performed alkaline gelatinization for 0.5 to 2 h. After alkaline gelatinization treatment, potassium persulfate is added as the initiator to the system; glycidyl methacrylate and acrylic acid solution are added into the mixed solution, and a grafting reaction is carried out. After the reaction is completed, ethanol or acetone is used as the precipitant for precipitation and separation, and a green and efficient multifunctional-group modified scale inhibitor is obtained.

Preferably, the mass ratio of the starch to the sodium hydroxide is 1:0.1 to 1:2;
the alkaline gelatinization reaction process controls the reaction temperature at 60 to 95° C., with a reaction time of 0.5 to 3 h;
the mass ratio of the starch to the glycidyl methacrylate is 1:0.2 to 1:2, and the mass ratio of the starch to the acrylic acid is 1:0.01 to 1:0.5;
the grafting reaction process controls the reaction temperature at 50 to 80° C. and the reaction time for 1 to 4 h.

Preferably, the mass ratio of the starch to the sodium hydroxide is 1:0.3;
the alkaline gelatinization reaction process controls the reaction temperature at 75° C., with a reaction time of 1 h;
the mass ratio of the starch to the glycidyl methacrylate is to 1:0.5, and the mass ratio of the starch to the acrylic acid is to 1:0.15;

The grafting reaction process controls the reaction temperature at 65° C. and the reaction time for 3 h.

To solve the above technical problem, another technical solution provided by the present invention is: the prepared multifunctional-group modified environmental-friendly scale inhibitor.

To solve the above technical problem, another technical solution provided by the present invention is: the application of the multifunctional-group modified environmental-friendly scale inhibitor. Said multifunctional-group modified environmental-friendly scale inhibitor can not only effectively inhibit the formation of calcium sulfate scale in static water bodies, but also effectively alleviate the decline of membrane flux in the reverse osmosis system, thereby improving the stability of the water treatment system.

Preferably, first, starch is mixed with sodium hydroxide aqueous solution, where a mass ratio of starch to sodium hydroxide is 1:0.3, and stirred at 75° C. to fully gelatinize the starch for 1 h; after alkaline gelatinization treatment, potassium persulfate is added as an initiator; subsequently, a mixed aqueous solution of glycidyl methacrylate and acrylic acid with a mass ratio of 1:0.5:0.15 (starch:glycidyl methacrylate:acrylic acid) is added dropwise to a reaction system through a constant pressure separating funnel; after the dropwise addition had been completed, the reaction is carried out at 65° C. for 3 h, and the entire reaction is maintained in a nitrogen atmosphere; after the reaction, a pH value of a reaction solution is adjusted to neutral, and then ethanol or acetone is used as a precipitant to precipitate and separate the reaction solution to obtain a final product, a green and efficient multifunctional-group modified scale inhibitor; when the dosage of the obtained multifunctional-group modified environmental-friendly scale inhibitor is 10.0 mg/L, a static scale inhibition efficiency for CaSO₄ reaches 100%; after adding 5.0 mg/L of the scale inhibitor and operating for 24 h, a membrane flux increases to 83% compared with that without the scale inhibitor.

### The Beneficial Effects of the Present Invention

1. This green and efficient multifunctional-group modified scale inhibitor obtained by the preparation method of the present invention has carboxyl group, ester group, epoxy group and other functional groups. Unlike the previous modification using a single anionic functional group, ester groups and epoxy groups are non-ionic functional groups. These functional groups can not only effectively delay the formation of calcium sulfate crystals through chelation, but also exhibit excellent dispersion and lattice distortion effects. In addition, due to their non-ionic property, it is not prone to produce flocculation effect, thus not prone to contaminate the reverse osmosis membrane under high dosage. Through static experiments, it can effectively inhibit the formation of calcium sulfate at both lower dosage of 10 mg/L and higher dosage of 80 mg/L, showing good scale inhibition performance in a wide dosage range. In application in reverse osmosis experiments, it can effectively inhibit the formation of calcium sulfate at both lower dosage of 2 mg/L and higher dosage of 20 mg/L, showing good scale inhibition performance in a wide dosage range also.
2. The present invention can not only be used in cooling circulating water in high-temperature and high-hardness environments, but also be suitable for reverse osmosis treatment under high pressure, can deal with different ions and pollutants, and is not prone to secondary pollution with the membrane.
3. The preparation method of this green and efficient multifunctional-group modified scale inhibitor in the present invention is simple in operation, short in synthesis time, the main raw materials used are natural polymer products with abundant sources, low cost, suitable for large-scale industrial production, and is an economical preparation method for obtaining high-quality water treatment agents.
4. This green and efficient multifunctional-group modified scale inhibitor in the present invention possesses excellent scale inhibition performance, can interact with fouling substances through complexation and dispersion effects, reduce the crystal nucleation rate, significantly prolong the crystallization induction time, inhibit the formation of calcium sulfate scale, thereby effectively delaying fouling contamination on the membrane surface and alleviating the decline in membrane flux.
5. This green and efficient multifunctional-group modified scale inhibitor has a wide effective dosage range, and does not require strict control of dosage during use.
6. This green and efficient multifunctional-group modified scale inhibitor uses natural polymer starch as the raw material, has biodegradability, low cost, and is non-toxic itself, and will not cause secondary pollution to water bodies.
7. Embodiment 1 is the preferred embodiment, and FIG. 4 shows the scale inhibition efficiency of this green and efficient multifunctional-group modified scale inhibitor in the static scale inhibition experiment. Chinese National Standard (GB/T 16632-2019) is used to evaluate the scale inhibition performance of this green and efficient multifunctional-group modified scale inhibitor on CaSO₄. When the dosage is 10.0 mg/L, the efficiency of static scale inhibition efficiency reaches 100% (FIG. 4).

The scale inhibition performance of the scale inhibitor in the reverse osmosis system is evaluated by the cross-flow high-pressure flat membrane apparatus, with simulated seawater as the object of investigation; the mass of the permeate automatically recorded by the balance is used to calculate the permeation flux. It can be seen from FIG. 5 that, after adding 5.0 mg/L scale inhibitor, the normalized membrane flux at the operation time of 24 h increased from 4% to more than 83% compared with the situation where no scale inhibitor added, and the membrane fouling was greatly alleviated. Furthermore, under the same dosage condition, compared with two commercial scale inhibitors (aminotrimethylene phosphonic acid) and polyacrylic acid (with a weight-average molecular weight of 3000)), the final normalized membrane flux of this green and efficient multifunctional-group modified scale inhibitor is 83.2%, but the final normalized membrane fluxes of aminotrimethylene phosphonic acid and polyacrylic acid are 74.4% and 70.2% respectively (FIG. 5). This green and efficient multifunctional-group modified scale inhibitor not only achieves better membrane flux, but also is more environmentally friendly because it does not contain phosphorus. As can be seen from FIG. 6, this green and efficient multifunctional-group modified scale inhibitor, at a dosage of 2.0 mg/L, after 3 h of operation, the normalized membrane flux increases from 27.5% to 93.2% compared with that without addition of the scale inhibitor; at an excessive dosage of 20.0 mg/L, the final normalized membrane flux can still be maintained at 95.5%, thus, it has a wide effective dosage range and can mitigate scaling on the membrane surface within a wide dosage range.

### BRIEF DESCRIPTION OF THE DRAWINGS

Hereinafter, the present invention will be further described with reference to the accompanying drawings.

FIG. 1 is a schematic diagram of synthesis of this green and efficient multifunctional-group modified scale inhibitor (GEMSI).

FIG. 2 is an infrared spectra of GEMSI and starch.

FIG. 3 is a proton nuclear magnetic resonance spectra of GEMSI and starch.

FIG. 4 shows a scale inhibition efficiency of GEMSI in static scale inhibition experiment.

FIG. 5 shows effect on reverse osmosis membrane flux without adding any scale inhibitor, adding a GEMSI, and adding two commercial scale inhibitors including aminotrimethylene phosphonic acid and polyacrylic acid.

FIG. 6 shows effect of GEMSI without addition and under different dosages on reverse osmosis membrane flux.

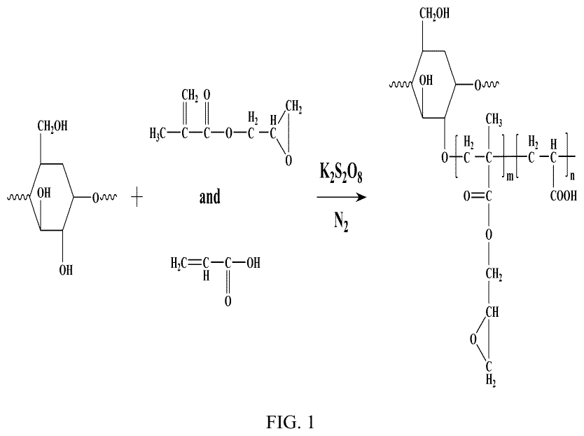

### DETAILED DESCRIPTION OF THE INVENTION

The present invention is further illustrated below by way of an embodiment. It should be understood that these embodiments are illustrations and examples of the present invention and do not limit the scope of the present invention in any form.

### Embodiment 1

A green and efficient multifunctional-group modified scale inhibitor, for which starch is used as the raw material, potassium persulfate is used as the initiator, glycidyl methacrylate (GMA) and acrylic acid (AA) are used as grafting monomers, a green and efficient multifunctional-group modified scale inhibitor targeting calcium sulfate scale (with a weight-average molecular weight of approximately 2.3×10⁵ g/mol) is obtained through graft copolymerization reaction. The preparation route is as follows:

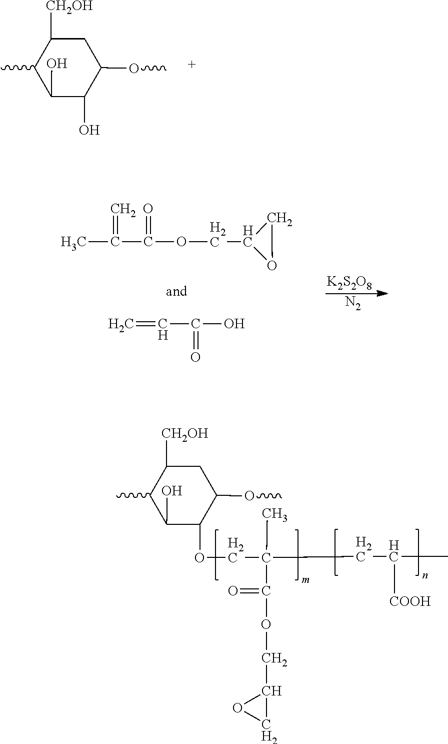

where: m, n are positive integers;

The specific steps are as follows: first, starch was mixed with sodium hydroxide aqueous solution, where a mass ratio of starch to sodium hydroxide is 1:0.3, and the mixture was stirred at 75° C. to allow the starch to be sufficiently gelatinized for 1 h. After alkaline gelatinization treatment, potassium persulfate was added as the initiator. Subsequently, the mixed aqueous solution of glycidyl methacrylate and acrylic acid with a mass ratio to starch of 1:0.5:0.15 (starch:glycidyl methacrylate:acrylic acid) was added dropwise to the reaction system via a constant pressure separating funnel. After the dropwise addition had been completed, the mixture was reacted at 65° C. for 3 h, and the entire reaction was maintained in a nitrogen atmosphere. After the reaction, a pH value of the reaction solution was adjusted to neutral, then ethanol or acetone was used as the precipitant to precipitate and separate the reaction solution to obtain a final product, a green and efficient multifunctional-group modified scale inhibitor.

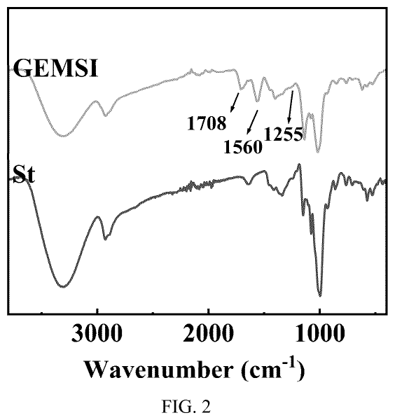

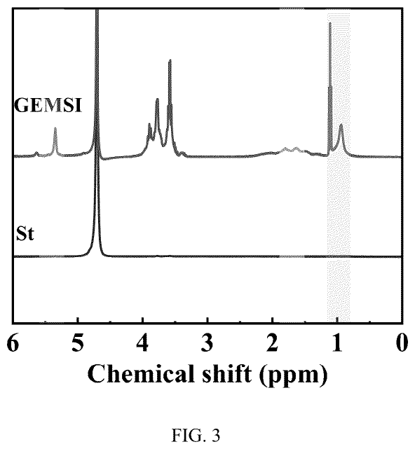

The infrared spectra of this green and efficient multifunctional-group modified scale inhibitor and starch are as shown in FIG. 2. As seen from FIG. 2, the green and efficient multifunctional-group modified scale inhibitor shows new characteristic peaks at 1701 cm⁻¹, 1560 cm⁻¹ and 1255 cm⁻¹, corresponding to the characteristic peaks of carbonyl group, ester group and epoxy group respectively, thus proving that the green and efficient multifunctional-group modified scale inhibitor is successfully prepared. In addition, as shown in FIG. 3, in the proton nuclear magnetic resonance spectrum, new characteristic peaks appear at 0.93-1.08 ppm, 1.8-2.0 ppm and 5.3-5.7 ppm respectively due to proton vibrations on —CH₃, —CH₂— and —COOH in this green and efficient multifunctional-group modified scale inhibitor.

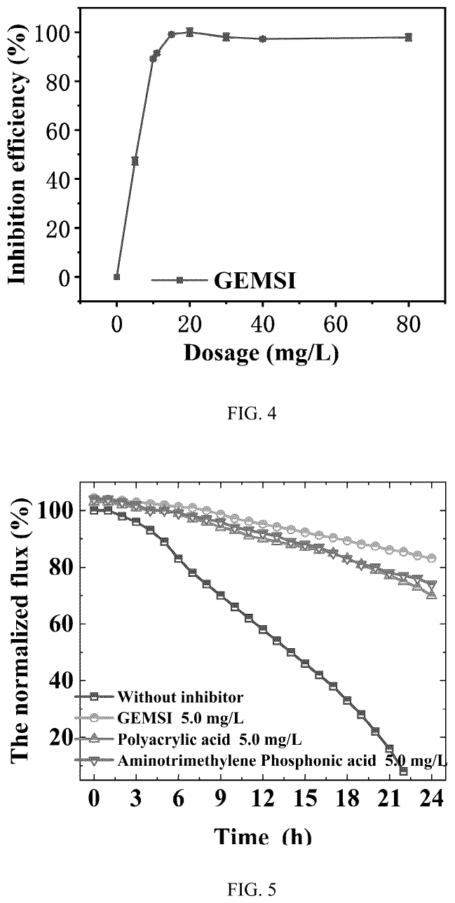

FIG. 4 shows the scale inhibition efficiency of this green and efficient multifunctional-group modified scale inhibitor in static scale inhibition experiment. Chinese National Standard (GB/T 16632-2019) is used to evaluate the scale inhibition performance of this green and efficient multifunctional-group modified scale inhibitor on CaSO₄. When the dosage is 10.0 mg/L, the efficiency of static scale inhibition efficiency reaches 100% (FIG. 4).

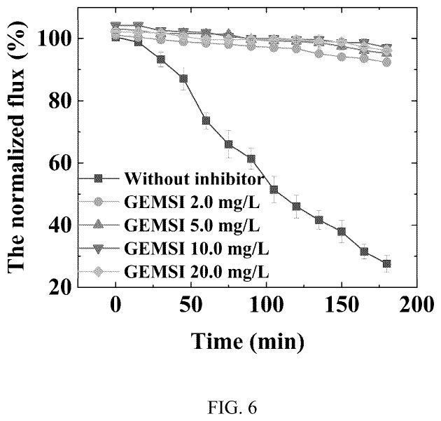

The scale inhibition performance of this scale inhibitor in the reverse osmosis system is evaluated by the cross-flow high-pressure flat membrane apparatus, with simulated seawater as the object of investigation; the mass of the permeate automatically recorded by the balance is used to calculate the permeation flux. It can be seen from FIG. 5 that, after adding 5.0 mg/L scale inhibitor, the normalized membrane flux at the operation time of 24 h increased from 4% to more than 83% compared with the situation where no scale inhibitor added, and the membrane fouling was greatly alleviated. Furthermore, under the same dosage condition, compared with two commercial scale inhibitors (aminotrimethylene phosphonic acid) and polyacrylic acid (with a weight-average molecular weight of 3000)), the final normalized membrane flux of the green and efficient multifunctional-group modified scale inhibitor is 83.2%, and the final normalized membrane fluxes of aminotrimethylene phosphonic acid and polyacrylic acid are 74.4% and 70.2% respectively (FIG. 5). This green and efficient multifunctional-group modified scale inhibitor not only achieves better membrane flux, but also is more environmentally friendly because it does not contain phosphorus. As can be seen from FIG. 6, the green and efficient multifunctional-group modified scale inhibitor, at a dosage of 2.0 mg/L, after 3 h of operation, the normalized membrane flux increases from 27.5% to 93.2% compared with that without the scale inhibitor; at an excessive dosage of 20.0 mg/L, the final normalized membrane flux can still be maintained at 95.5%, thus, it has a wide effective dosage range and can mitigate scaling on the membrane surface within a wide dosage range.

### Embodiment 2

First, cellulose (Sample 2.1) and chitosan (Sample 2.2) were used as substrates and mixed with sodium hydroxide aqueous solution respectively, where the mass ratio of substrate to sodium hydroxide was 1:0.3, and the mixture was stirred at 75° C. to allow the substrate to be sufficiently gelatinized for 1 h. After alkaline gelatinization treatment, potassium persulfate was added as the initiator. Subsequently, the mixed aqueous solution of glycidyl methacrylate and acrylic acid with a mass ratio to substrate of 1:0.5:0.15 (substrate:glycidyl methacrylate:acrylic acid) was added dropwise to the reaction system via a constant pressure separating funnel. After the dropwise addition had been completed, the mixture was reacted at 65° C. for 3 h, and the entire reaction was maintained in a nitrogen atmosphere. After the reaction, a pH value of the reaction solution was adjusted to neutral, then ethanol or acetone was used as the precipitant to precipitate and separate the reaction solution to obtain a final product, a green and efficient multifunctional-group modified scale inhibitor. Chinese National Standard (GB/T 16632-2019) is used to evaluate the scale inhibition performance of the inhibitor on CaSO₄. For Sample 2.1, the static scale inhibition efficiency reaches 100% at a dosage of 15.0 mg/L, and for Sample 2.2, the static scale inhibition efficiency reaches 100% at a dosage of 18.0 mg/L. The scale inhibition performance of the scale inhibitor in the reverse osmosis system is evaluated by the cross-flow high-pressure flat membrane apparatus, with simulated seawater as the object of investigation; the mass of the permeate automatically recorded by the balance is used to calculate the permeation flux. After adding 5.0 mg/L of Samples 2.1 and 2.2, the normalized membrane flux at the operation time of 24 h increases from 4% to more than 72% and 70% respectively compared with that without adding the scale inhibitor. Within a wide dosage range of 2.0-20.0 mg/L, after operating for 3 h, the final normalized membrane fluxes of Samples 2.1 and 2.2 increase from 27.5% to more than 85% and 82% respectively compared with that without the scale inhibitor.

Compared with Embodiment 1, changing the type of substrates will reduce the scale inhibition efficiency of the scale inhibitor.

### Embodiment 3

First, starch was used as the substrate and mixed with sodium hydroxide aqueous solution respectively; in Sample 3.1, the mass ratio of starch to sodium hydroxide was 1:0.1, and stirred at 75° C. to fully gelatinize the starch for 1 h; in Sample 3.2, the mass ratio of starch to sodium hydroxide was 1:2, and stirred at 75° C. to fully gelatinize the starch for 1 h. After alkaline gelatinization treatment, potassium persulfate was added as the initiator. Subsequently, the mixed aqueous solution of glycidyl methacrylate and acrylic acid with a mass ratio to starch of 1:0.5:0.15 (starch:glycidylmethacrylate:acrylic acid) was added dropwise to the reaction system via a constant pressure separating funnel. After the dropwise addition had been completed, the mixture was reacted at 65° C. for 3 h, and the entire reaction was maintained in a nitrogen atmosphere. After the reaction, a pH value of the reaction solution was adjusted to neutral, then ethanol or acetone was used as the precipitant to precipitate and separate the reaction solution to obtain a final product, a green and efficient multifunctional-group modified scale inhibitor. Chinese National Standard (GB/T 16632-2019) is used to evaluate the scale inhibition performance of the inhibitor on CaSO₄. For Sample 3.1, the static scale inhibition efficiency reaches 100% at a dosage of 30.0 mg/L, and for Sample 3.2, the static scale inhibition efficiency reaches 100% at a dosage of 25.0 mg/L. The scale inhibition performance of the scale inhibitor in the reverse osmosis system is evaluated by the cross-flow high-pressure flat membrane apparatus, with simulated seawater as the object of investigation; the mass of the permeate automatically recorded by the balance is used to calculate the permeation flux. After adding 5.0 mg/L of Samples 3.1 and 3.2, the normalized membrane flux at the operation time of 24 h increases from 4% to more than 65% and 68% respectively compared with that without adding the scale inhibitor. Within a wide dosage range of 2.0-20.0 mg/L, after operating for 3 h, the final normalized membrane fluxes of Samples 3.1 and 3.2 increase from 27.5% to more than 76% and 79% respectively compared with that without the scale inhibitor.

Compared with Embodiment 1, changing the mass of sodium hydroxide in alkaline gelatinization will reduce the scale inhibition efficiency of the scale inhibitor.

### Embodiment 4

First, starch was used as the substrate and mixed with sodium hydroxide aqueous solution respectively; in Sample 4.1, the mass ratio of starch to sodium hydroxide was 1:0.3, and stirred at 60° C. to fully gelatinize the starch for 3 h; in Sample 4.2, the mass ratio of starch to sodium hydroxide was 1:0.3, and stirred at 95° C. to fully gelatinize the starch for 0.5 h. After alkaline gelatinization treatment, potassium persulfate was added as the initiator. Subsequently, the mixed aqueous solution of glycidyl methacrylate and acrylic acid with a mass ratio to starch of 1:0.5:0.15 (starch:glycidylmethacrylate:acrylic acid) was added dropwise to the reaction system via a constant pressure separating funnel. After the dropwise addition had been completed, the mixture was reacted at 65° C. for 3 h, and the entire reaction was maintained in a nitrogen atmosphere. After the reaction, a pH value of the reaction solution was adjusted to neutral, then ethanol or acetone was used as the precipitant to precipitate and separate the reaction solution to obtain a final product, a green and efficient multifunctional-group modified scale inhibitor. Chinese National Standard (GB/T 16632-2019) is used to evaluate the scale inhibition performance of the inhibitor on CaSO₄. For Sample 4.1, the static scale inhibition efficiency reaches 100% at a dosage of 16.0 mg/L, and for Sample 4.2, the static scale inhibition efficiency reaches 100% at a dosage of 13.0 mg/L. The scale inhibition performance of the scale inhibitor in the reverse osmosis system is evaluated by the cross-flow high-pressure flat membrane apparatus, with simulated seawater as the object of investigation; the mass of the permeate automatically recorded by the balance is used to calculate the permeation flux. After adding 5.0 mg/L of Samples 4.1 and 4.2, the normalized membrane flux at the operation time of 24 h increases from 4% to more than 72% and 76% respectively compared with that without adding the scale inhibitor. Within a wide dosage range of 2.0-20.0 mg/L, after operating for 3 h, the final normalized membrane fluxes of Samples 4.1 and 4.2 increase from 27.5% to more than 79% and 82% respectively compared with that without the scale inhibitor.

Compared with Embodiment 1, changing the temperature and time in alkaline gelatinization will reduce the scale inhibition efficiency of the scale inhibitor.

### Embodiment 5

First, starch was used as the substrate and mixed with sodium hydroxide aqueous solution, where the mass ratio of starch to sodium hydroxide was 1:0.3, and stirred at 75° C. to fully gelatinize the starch for 1 h. After alkaline gelatinization treatment, potassium persulfate was added as the initiator. Subsequently, mixed aqueous solutions of glycidyl methacrylate and acrylic acid with mass ratios of 1:0.2:0.5 (starch:glycidylmethacrylate:acrylic acid) (Sample 5.1) and 1:2:0.01 (starch:glycidyl methacrylate:acrylic acid) (Sample 5.2) to the starch were added dropwise to the reaction system through a constant pressure separating funnel. After the dropwise addition had been completed, the mixture was reacted at 65° C. for 3 h, and the entire reaction was maintained in a nitrogen atmosphere. After the reaction, a pH value of the reaction solution was adjusted to neutral, then ethanol or acetone was used as the precipitant to precipitate and separate the reaction solution to obtain a final product, a green and efficient multifunctional-group modified scale inhibitor. Chinese National Standard (GB/T 16632-2019) is used to evaluate the scale inhibition performance of the inhibitor on CaSO₄. For Sample 5.1, the static scale inhibition efficiency reaches 100% at a dosage of 17.0 mg/L, and for Sample 5.2, the static scale inhibition efficiency reaches 100% at a dosage of 20.0 mg/L. The scale inhibition performance of the scale inhibitor in the reverse osmosis system is evaluated by the cross-flow high-pressure flat membrane apparatus, with simulated seawater as the object of investigation; the mass of the permeate automatically recorded by the balance is used to calculate the permeation flux. After adding 5.0 mg/L of Samples 5.1 and 5.2, the normalized membrane flux at the operation time of 24 h increases from 4% to more than 63% and 77% respectively compared with that without adding the scale inhibitor. Within a wide dosage range of 2.0-20.0 mg/L, after operating for 3 h, the final normalized membrane fluxes of Samples 5.1 and 5.2 increase from 27.5% to more than 69% and 86% respectively compared with that without the scale inhibitor.

Compared with Embodiment 1, changing the mass ratio of the feed will reduce the scale inhibition efficiency of the scale inhibitor.

### Embodiment 6

First, starch was used as the substrate and mixed with sodium hydroxide aqueous solution, where the mass ratio of starch to sodium hydroxide was 1:0.3, and stirred at 75° C. to fully gelatinize the starch for 1 h. After alkaline gelatinization treatment, potassium persulfate was added as the initiator. Subsequently, the mixed aqueous solution of glycidyl methacrylate and acrylic acid with a mass ratio to starch of 1:0.5:0.15 (starch:glycidylmethacrylate:acrylic acid) was added dropwise to the reaction system via a constant pressure separating funnel. Sample 6.1 was reacted at 50° C. for 4 h; Sample 6.2 was reacted at 80° C. for 1 h, and the entire reaction was maintained in a nitrogen atmosphere. After the reaction, a pH value of the reaction solution was adjusted to neutral, then ethanol or acetone was used as the precipitant to precipitate and separate the reaction solution to obtain a final product, a green and efficient multifunctional-group modified scale inhibitor. Chinese National Standard (GB/T 16632-2019) is used to evaluate the scale inhibition performance of the inhibitor on CaSO₄. For Sample 6.1, the static scale inhibition efficiency reaches 100% at a dosage of 12.0 mg/L, and for Sample 6.2, the static scale inhibition efficiency reaches 100% at a dosage of 11.0 mg/L. The scale inhibition performance of the scale inhibitor in the reverse osmosis system is evaluated by the cross-flow high-pressure flat membrane apparatus, with simulated seawater as the object of investigation; the mass of the permeate automatically recorded by the balance is used to calculate the permeation flux. After adding 5.0 mg/L of Samples 6.1 and 6.2, the normalized membrane flux at the operation time of 24 h increases from 4% to more than 76% and 80% respectively compared with that without adding the scale inhibitor. Within a wide dosage range of 2.0-20.0 mg/L, after operating for 3 h, the final normalized membrane fluxes of Samples 6.1 and 6.2 increase from 27.5% to more than 76% and 88% respectively compared with that without the scale inhibitor.

Compared with Embodiment 1, changing the temperature and time of the grafting reaction will reduce the scale inhibition efficiency of the scale inhibitor.

The present invention is not limited to the specific technical solutions described in the above embodiments; all technical solutions formed by equivalent replacement shall fall within the protection scope claimed by the present invention.

1. Application of a multifunctional-group modified environmental-friendly scale inhibitor, characterized in that firstly, starch is mixed with sodium hydroxide aqueous solution, wherein a mass ratio of starch to sodium hydroxide is 1:0.3, and stirred at 75° C. to fully gelatinize the starch for 1 h; after alkaline gelatinization treatment, potassium persulfate is added as an initiator; subsequently, a mixed aqueous solution of glycidyl methacrylate and acrylic acid with a mass ratio of 1:0.5:0.15 (starch:glycidylmethacrylate:acrylic acid) is added dropwise to a reaction system through a constant pressure separating funnel; after the dropwise addition had been completed, the reaction is carried out at 65° C. for 3 h, and the entire reaction is maintained in a nitrogen atmosphere; after the reaction, a pH value of a reaction solution is adjusted to neutral, and then ethanol or acetone is used as a precipitant to precipitate and separate the reaction solution to obtain a final product, a green and efficient multifunctional-group modified scale inhibitor; when the dosage of the obtained multifunctional-group modified environmental-friendly scale inhibitor is 10.0 mg/L, a static scale inhibition efficiency for CaSO₄ reaches 100%; after adding 2.0 mg/L of the scale inhibitor and operating for 3 h, a normalized membrane flux increases to 93.2% compared with that without the scale inhibitor; at an excessive dosage of 20.0 mg/L, the final normalized membrane flux can still be maintained at 95.5%, so it has a wide effective dosage range and can reduce scaling on a membrane surface within a wide dosage range.
